(19) United States
(12) Patent Application Publication
(10) Pub. No.: US 2019/0076874 A1
(43) Pub. Date: Mar. 14, 2019

(54) METHOD FOR COLOR-REGISTER SPRAYING OF HUB

(71) Applicant: CITIC Dicastal CO., LTD., Qinhuangdao (CN)

(72) Inventors: Qun Zhao, Qinhuangdao (CN); Lei Bao, Qinhuangdao (CN); Le Wang, Qinhuangdao (CN); Guangca Chen, Qinhuangdao (CN); Shengchao Zhang, Qinhuangdao (CN)

(21) Appl. No.: 16/114,699

(22) Filed: Aug. 28, 2018

(30) Foreign Application Priority Data
Sep. 13, 2017 (CN) 201710822696.X

(51) Int. Cl. B05D 1/06; B05D 3/10; B05D 3/12; B05D 5/06

(52) U.S. Cl. CPC B05D 1/06; B05D 3/108; B05D 7/14; B05D 5/06; B05D 3/12

(57) ABSTRACT

A method for color-register spraying of a hub includes: after a black paint is sprayed onto the surface of the hub, machining a turned glossy surface, and then spraying the hub with a color celluloid paint. The method achieves a color-register spraying effect by spraying the color celluloid paint, greatly improves the production efficiency, and can achieve batch production.

### CROSS-REFERENCE TO RELATED APPLICATIONS

The present application claims benefit of Chinese Patent Application No. 201710822696.X, filed on Sep. 13, 2017, the contents of which are hereby incorporated by reference in its entirety.

### BACKGROUND

At present, the hub is relatively single in color. The existing color-register process is mainly achieved by protection, but has the problems that the color-register edge is not clear and needs to be partially repaired by manual operation, the yield is low, the labor cost is high and the like, so it is not suitable for batch production.

### SUMMARY

The present disclosure relates to the manufacturing field of automobile parts, and specifically, relates to a method for color-register spraying of a hub.

Accordingly, the objective of the present disclosure is to provide a hub printing method which is simple in process and clear in color-register edge.

In one aspect of the present disclosure, provided is a method for color-register spraying of a hub. The method is characterized by including: after a black paint is sprayed onto the surface of the hub, machining a turned glossy surface, and then spraying the hub with a color celluloid paint.

In a preferred aspect of the present disclosure, the method includes the steps of: pretreating→drying→spraying base powder→curing→spraying a black paint→curing→machining a turned glossy surface→pretreating→drying→spraying transparent powder→curing→spraying a color celluloid paint→curing.

In a preferred aspect of the present disclosure, the method adopts one or more of the following working conditions: (1) in the process of spraying base powder, an electrostatic spray gun is adopted for spraying, the voltage is controlled at 60˜80 KV, and the powder output is controlled at 10˜15 g/s, thereby ensuring excellent adhesion between coatings; (2) in the process of curing the base powder, the surface temperature of a workpiece is controlled at 180° C. for 8˜12 min, so that the powder maintains certain flexibility and better coating adhesion; (3) in the process of spraying a black paint, an air spray gun is adopted for spraying, the air output is controlled at 50˜100 cc/min, and the atomizing sector pressure is 2˜3 bar, so that the black paint is uniformly and fully sprayed on the surface of the hub; (4) in the process of curing the black paint, the temperature of the workpiece is controlled at 150° C. for 10˜15 min, so that the black paint has good flexibility and coating adhesion; (5) in the process of machining a turned glossy surface, the revolving speed S is controlled at 1200 rpm, and the feed rate F is 0.2 mm/r; (6) in the process of spraying transparent powder, the electrostatic spray gun is adopted for spraying, the voltage is controlled at 60˜80 KV, and the powder output is controlled at 10˜15 g/s, thereby ensuring excellent adhesion between coatings; (7) in the process of curing the transparent powder, the surface temperature of the workpiece is controlled at 177° C. for 10˜15 min, so that the powder maintains certain flexibility and better coating adhesion; (8) in the process of spraying a color celluloid paint, a rotary cup spray gun is adopted for spraying, the revolving speed is 25000 R/min, the forming gas is 2˜3 bar, and the paint output pressure is 4˜5 bar, thereby ensuring that the color celluloid paint is uniformly and fully sprayed on the surface of the hub; and (9) in the process of curing the color celluloid paint, the temperature of the workpiece is controlled at 150° C. for 10˜15 min, so that the color celluloid paint has better flexibility and coating adhesion.

In a preferred aspect of the present disclosure, in the process of spraying base powder, an electrostatic spray gun is adopted for spraying, the voltage is controlled at 60 KV, and the powder output is controlled at 10 g/s, thereby ensuring excellent adhesion between coatings; in the process of curing the base powder, the surface temperature of a workpiece is controlled at 180° C. for 8 min, so that the powder maintains certain flexibility and better coating adhesion; in the process of spraying a black paint, an air spray gun is adopted for spraying, the air output is controlled at 50 cc/min, and the atomizing sector pressure is 2 bar, so that the black paint is uniformly and fully sprayed on the surface of the hub; in the process of curing the black paint, the temperature of the workpiece is controlled at 150° C. for 10 min, so that the black paint has good flexibility and coating adhesion; in the process of machining a turned glossy surface, the revolving speed S is controlled at 1200 rpm, and the feed rate F is 0.2 mm/r; in the process of spraying transparent powder, the electrostatic spray gun is adopted for spraying, the voltage is controlled at 60 KV, and the powder output is controlled at 10 g/s, thereby ensuring excellent adhesion between coatings; in the process of curing the transparent powder, the surface temperature of the workpiece is controlled at 177° C. for 8 min, so that the powder maintains certain flexibility and better coating adhesion; in the process of spraying a color celluloid paint, a rotary cup spray gun is adopted for spraying, and the revolving speed is 25000 R/min; and in the process of curing the color celluloid paint, the temperature of the workpiece is controlled at 150° C. for 10 min, so that the color celluloid paint has better flexibility and coating adhesion.

In a preferred aspect of the present disclosure, in the process of spraying base powder, an electrostatic spray gun is adopted for spraying, the voltage is controlled at 70 KV, and the powder output is controlled at 12 g/s, thereby ensuring excellent adhesion between coatings; in the process of curing the base powder, the surface temperature of a workpiece is controlled at 180° C. for 10 min, so that the powder maintains certain flexibility and better coating adhesion; in the process of spraying a black paint, an air spray gun is adopted for spraying, the air output is controlled at 80 cc/min, and the atomizing sector pressure is 2.5 bar, so that the black paint is uniformly and fully sprayed on the surface of the hub; in the process of curing the black paint, the temperature of the workpiece is controlled at 150° C. for 12 min, so that the black paint has good flexibility and coating adhesion; in the process of machining a turned glossy surface, the revolving speed S is controlled at 1200 rpm, and the feed rate F is 0.2 mm/r; in the process of spraying transparent powder, the electrostatic spray gun is adopted for spraying, the voltage is controlled at 70 KV, and the powder output is controlled at 12 g/s, thereby ensuring excellent adhesion between coatings; in the process of curing the transparent powder, the surface temperature of the workpiece is controlled at 177° C. for 12 min, so that the powder maintains certain flexibility and better coating adhesion; in the process of spraying a color celluloid paint, a rotary cup spray gun is adopted for spraying, the revolving speed is 25000 R/min, the forming gas is 2.5 bar, and the paint output pressure is 4.5 bar, thereby ensuring that the color celluloid paint is uniformly and fully sprayed on the surface of the hub; and in the process of curing the color celluloid paint, the temperature of the workpiece is controlled at 150° C. for 12 min, so that the color celluloid paint has better flexibility and coating adhesion.

In a preferred aspect of the present disclosure, in the process of spraying base powder, an electrostatic spray gun is adopted for spraying, the voltage is controlled at 80 KV, and the powder output is controlled at 15 g/s, thereby ensuring excellent adhesion between coatings; in the process of curing the base powder, the surface temperature of a workpiece is controlled at 180° C. for 12 min, so that the powder maintains certain flexibility and better coating adhesion; in the process of spraying a black paint, an air spray gun is adopted for spraying, the air output is controlled at 100 cc/min, and the atomizing sector pressure is 3 bar, so that the black paint is uniformly and fully sprayed on the surface of the hub; in the process of curing the black paint, the temperature of the workpiece is controlled at 150° C. for 15 min, so that the black paint has good flexibility and coating adhesion; in the process of machining a turned glossy surface, the revolving speed S is controlled at 1200 rpm, and the feed rate F is 0.2 mm/r; in the process of spraying transparent powder, the electrostatic spray gun is adopted for spraying, the voltage is controlled at 80 KV, and the powder output is controlled at 15 g/s, thereby ensuring excellent adhesion between coatings; in the process of curing the transparent powder, the surface temperature of the workpiece is controlled at 177° C. for 15 min, so that the powder maintains certain flexibility and better coating adhesion; in the process of spraying a color celluloid paint, a rotary cup spray gun is adopted for spraying, the revolving speed is 25000 R/min, the forming gas is 3 bar, and the paint output pressure is 5 bar, thereby ensuring that the color celluloid paint is uniformly and fully sprayed on the surface of the hub; and in the process of curing the color celluloid paint, the temperature of the workpiece is controlled at 150° C. for 15 min, so that the color celluloid paint has better flexibility and coating adhesion.

In other aspect of the present disclosure, further disclosed is the following technical solution:

In order to solve the technological deficiencies of color registration of the hub, the present disclosure provides a novel hub color-register spraying process.

The specific process flow of the present disclosure is: pretreating→drying→spraying base powder→curing→spraying a black paint→curing→machining a turned glossy surface→pretreating→drying→spraying transparent powder→curing→spraying a color celluloid paint→curing.

In the process of spraying base powder, an electrostatic spray gun is adopted for spraying, the voltage is controlled at 60˜80 KV, and the powder output is controlled at 10˜15 g/s, thereby ensuring excellent adhesion between coatings.

In the process of curing the base powder, the surface temperature of a workpiece is controlled at 180° C. for 8˜12 min, so that the powder maintains certain flexibility and better coating adhesion.

In the process of spraying a black paint, an air spray gun is adopted for spraying, the air output is controlled at 50˜100 cc/min, and the atomizing sector pressure is 2˜3 bar, thereby ensuring that the black paint is uniformly and fully sprayed on the surface of the hub.

In the process of curing the black paint, the temperature of the workpiece is controlled at 150° C. for 10˜15 min, so that the black paint has good flexibility and coating adhesion.

In the process of machining a turned glossy surface, the revolving speed S is controlled at 1200 rpm, and the feed rate F is 0.2 mm/r.

In the process of spraying transparent powder, the electrostatic spray gun is adopted for spraying, the voltage is controlled at 60˜80 KV, and the powder output is controlled at 10˜15 g/s, thereby ensuring excellent adhesion between coatings.

In the process of curing the transparent powder, the surface temperature of the workpiece is controlled at 177° C. for 10˜15 min, so that the powder maintains certain flexibility and better coating adhesion.

In the process of spraying a color celluloid paint, a rotary cup spray gun is adopted for spraying, the revolving speed is 25000 R/min, the forming gas is 2˜3 bar, and the paint output pressure is 4˜5 bar, thereby ensuring that the color celluloid paint is uniformly and fully sprayed on the surface of the hub.

In the process of curing the color celluloid paint, the temperature of the workpiece is controlled at 150° C. for 10˜15 min, so that the color celluloid paint has better flexibility and coating adhesion.

The present disclosure achieves a color-register spraying effect by spraying the color celluloid paint, greatly improves the production efficiency, and can achieve batch production.

In a preferred aspect, in the process of spraying base powder, an electrostatic spray gun is adopted for spraying, the voltage is controlled at 60 KV, and the powder output is controlled at 10 g/s, thereby ensuring excellent adhesion between coatings. In the process of curing the base powder, the surface temperature of a workpiece is controlled at 180° C. for 8 min, so that the powder maintains certain flexibility and better coating adhesion. In the process of spraying a black paint, an air spray gun is adopted for spraying, the air output is controlled at 50 cc/min, and the atomizing sector pressure is 2 bar, thereby ensuring that the black paint is uniformly and fully sprayed on the surface of the hub. In the process of curing the black paint, the temperature of the workpiece is controlled at 150° C. for 10 min, so that the black paint has good flexibility and coating adhesion. In the process of machining a turned glossy surface, the revolving speed S is controlled at 1200 rpm, and the feed rate F is 0.2 mm/r. In the process of spraying transparent powder, the electrostatic spray gun is adopted for spraying, the voltage is controlled at 60 KV, and the powder output is controlled at 10 g/s, thereby ensuring excellent adhesion between coatings. In the process of curing the transparent powder, the surface temperature of the workpiece is controlled at 177° C. for 8 min, so that the powder maintains certain flexibility and better coating adhesion. In the process of spraying a color celluloid paint, a rotary cup spray gun is adopted for spraying, the revolving speed is 25000 R/min, the forming gas is 2 bar, and the paint output pressure is 4 bar, thereby ensuring that the color celluloid paint is uniformly and fully sprayed on the surface of the hub. In the process of curing the color celluloid paint, the temperature of the workpiece is controlled at 150° C. for 10 min, so that the color celluloid paint has better flexibility and coating adhesion.

In a preferred aspect of the present disclosure, in the process of spraying base powder, an electrostatic spray gun is adopted for spraying, the voltage is controlled at 70 KV, and the powder output is controlled at 12 g/s, thereby ensuring excellent adhesion between coatings. In the process of curing the base powder, the surface temperature of a workpiece is controlled at 180° C. for 10 min, so that the powder maintains certain flexibility and better coating adhesion. In the process of spraying a black paint, an air spray gun is adopted for spraying, the air output is controlled at 80 cc/min, and the atomizing sector pressure is 2.5 bar, thereby ensuring that the black paint is uniformly and fully sprayed on the surface of the hub. In the process of curing the black paint, the temperature of the workpiece is controlled at 150° C. for 12 min, so that the black paint has good flexibility and coating adhesion. In the process of machining a turned glossy surface, the revolving speed S is controlled at 1200 rpm, and the feed rate F is 0.2 mm/r. In the process of spraying transparent powder, the electrostatic spray gun is adopted for spraying, the voltage is controlled at 70 KV, and the powder output is controlled at 12 g/s, thereby ensuring excellent adhesion between coatings. In the process of curing the transparent powder, the surface temperature of the workpiece is controlled at 177° C. for 12 min, so that the powder maintains certain flexibility and better coating adhesion. In the process of spraying a color celluloid paint, a rotary cup spray gun is adopted for spraying, the revolving speed is 25000 R/min, the forming gas is 2.5 bar, and the paint output pressure is 4.5 bar, thereby ensuring that the color celluloid paint is uniformly and fully sprayed on the surface of the hub. In the process of curing the color celluloid paint, the temperature of the workpiece is controlled at 150° C. for 12 min, so that the color celluloid paint has better flexibility and coating adhesion.

In a preferred aspect of the present disclosure, in the process of spraying base powder, an electrostatic spray gun is adopted for spraying, the voltage is controlled at 80 KV, and the powder output is controlled at 15 g/s, thereby ensuring excellent adhesion between coatings. In the process of curing the base powder, the surface temperature of a workpiece is controlled at 180° C. for 12 min, so that the powder maintains certain flexibility and better coating adhesion. In the process of spraying a black paint, an air spray gun is adopted for spraying, the air output is controlled at 100 cc/min, and the atomizing sector pressure is 3 bar, thereby ensuring that the black paint is uniformly and fully sprayed on the surface of the hub. In the process of curing the black paint, the temperature of the workpiece is controlled at 150° C. for 15 min, so that the black paint has good flexibility and coating adhesion. In the process of machining a turned glossy surface, the revolving speed S is controlled at 1200 rpm, and the feed rate F is 0.2 mm/r. In the process of spraying transparent powder, the electrostatic spray gun is adopted for spraying, the voltage is controlled at 80 KV, and the powder output is controlled at 15 g/s, thereby ensuring excellent adhesion between coatings. In the process of curing the transparent powder, the surface temperature of the workpiece is controlled at 177° C. for 15 min, so that the powder maintains certain flexibility and better coating adhesion. In the process of spraying a color celluloid paint, a rotary cup spray gun is adopted for spraying, the revolving speed is 25000 R/min, the forming gas is 3 bar, and the paint output pressure is 5 bar, thereby ensuring that the color celluloid paint is uniformly and fully sprayed on the surface of the hub. In the process of curing the color celluloid paint, the temperature of the workpiece is controlled at 150° C. for 15 min, so that the color celluloid paint has better flexibility and coating adhesion.

The present disclosure achieves a color-register spraying effect by spraying the color celluloid paint, greatly improves the production efficiency, and can achieve batch production.

### DETAILED DESCRIPTION

### Embodiment 1

The specific process flow of a color celluloid paint color-register spraying process is: pretreating→drying→spraying base powder→curing→spraying a black paint→curing→machining a turned glossy surface→pretreating→drying→spraying transparent powder→curing→spraying a color celluloid paint→curing.

In the process of spraying base powder, an electrostatic spray gun is adopted for spraying, the voltage is controlled at 60 KV, and the powder output is controlled at 10 g/s, thereby ensuring excellent adhesion between coatings.

In the process of curing the base powder, the surface temperature of a workpiece is controlled at 180° C. for 8 min, so that the powder maintains certain flexibility and better coating adhesion.

In the process of spraying a black paint, an air spray gun is adopted for spraying, the air output is controlled at 50 cc/min, and the atomizing sector pressure is 2 bar, thereby ensuring that the black paint is uniformly and fully sprayed on the surface of the hub.

In the process of curing the black paint, the temperature of the workpiece is controlled at 150° C. for 10 min, so that the black paint has good flexibility and coating adhesion.

In the process of machining a turned glossy surface, the revolving speed S is controlled at 1200 rpm, and the feed rate F is 0.2 mm/r.

In the process of spraying transparent powder, the electrostatic spray gun is adopted for spraying, the voltage is controlled at 60 KV, and the powder output is controlled at 10 g/s, thereby ensuring excellent adhesion between coatings.

In the process of curing the transparent powder, the surface temperature of the workpiece is controlled at 177° C. for 8 min, so that the powder maintains certain flexibility and better coating adhesion.

In the process of spraying a color celluloid paint, a rotary cup spray gun is adopted for spraying, and the revolving speed is 25000 R/min.

In the process of curing the color celluloid paint, the temperature of the workpiece is controlled at 150° C. for 10 min, so that the color celluloid paint has better flexibility and coating adhesion.

### Embodiment 2

The specific process flow of a color celluloid paint color-register spraying process is: pretreating→drying→spraying base powder→curing→spraying a black paint→curing→machining a turned glossy surface→pretreating→drying→spraying transparent powder→curing→spraying a color celluloid paint→curing.

In the process of spraying base powder, an electrostatic spray gun is adopted for spraying, the voltage is controlled at 70 KV, and the powder output is controlled at 12 g/s, thereby ensuring excellent adhesion between coatings.

In the process of curing the base powder, the surface temperature of a workpiece is controlled at 180° C. for 10 min, so that the powder maintains certain flexibility and better coating adhesion.

In the process of spraying a black paint, an air spray gun is adopted for spraying, the air output is controlled at 80 cc/min, and the atomizing sector pressure is 2.5 bar, thereby ensuring that the black paint is uniformly and fully sprayed on the surface of the hub.

In the process of curing the black paint, the temperature of the workpiece is controlled at 150° C. for 12 min, so that the black paint has good flexibility and coating adhesion.

In the process of machining a turned glossy surface, the revolving speed S is controlled at 1200 rpm, and the feed rate F is 0.2 mm/r.

In the process of spraying transparent powder, the electrostatic spray gun is adopted for spraying, the voltage is controlled at 70 KV, and the powder output is controlled at 12 g/s, thereby ensuring excellent adhesion between coatings.

In the process of curing the transparent powder, the surface temperature of the workpiece is controlled at 177° C. for 12 min, so that the powder maintains certain flexibility and better coating adhesion.

In the process of spraying a color celluloid paint, a rotary cup spray gun is adopted for spraying, the revolving speed is 25000 R/min, the forming gas is 2.5 bar, and the paint output pressure is 4.5 bar, thereby ensuring that the color celluloid paint is uniformly and fully sprayed on the surface of the hub.

In the process of curing the color celluloid paint, the temperature of the workpiece is controlled at 150° C. for 12 min, so that the color celluloid paint has better flexibility and coating adhesion.

### Embodiment 3

The specific process flow of a color celluloid paint color-register spraying process is: pretreating→drying→spraying base powder→curing→spraying a black paint→curing→machining a turned glossy surface→pretreating→drying→spraying transparent powder→curing→spraying a color celluloid paint→curing.

In the process of spraying base powder, an electrostatic spray gun is adopted for spraying, the voltage is controlled at 80 KV, and the powder output is controlled at 15 g/s, thereby ensuring excellent adhesion between coatings.

In the process of curing the base powder, the surface temperature of a workpiece is controlled at 180° C. for 12 min, so that the powder maintains certain flexibility and better coating adhesion.

In the process of spraying a black paint, an air spray gun is adopted for spraying, the air output is controlled at 100 cc/min, and the atomizing sector pressure is 3 bar, thereby ensuring that the black paint is uniformly and fully sprayed on the surface of the hub.

In the process of curing the black paint, the temperature of the workpiece is controlled at 150° C. for 15 min, so that the black paint has good flexibility and coating adhesion.

In the process of machining a turned glossy surface, the revolving speed S is controlled at 1200 rpm, and the feed rate F is 0.2 mm/r.

In the process of spraying transparent powder, the electrostatic spray gun is adopted for spraying, the voltage is controlled at 80 KV, and the powder output is controlled at 15 g/s, thereby ensuring excellent adhesion between coatings.

In the process of curing the transparent powder, the surface temperature of the workpiece is controlled at 177° C. for 15 min, so that the powder maintains certain flexibility and better coating adhesion.

In the process of spraying a color celluloid paint, a rotary cup spray gun is adopted for spraying, the revolving speed is 25000 R/min, the forming gas is 3 bar, and the paint output pressure is 5 bar, thereby ensuring that the color celluloid paint is uniformly and fully sprayed on the surface of the hub.

In the process of curing the color celluloid paint, the temperature of the workpiece is controlled at 150° C. for 15 min, so that the color celluloid paint has better flexibility and coating adhesion.

1. A method for color-register spraying of a hub, comprising: after a black paint is sprayed onto a surface of the hub, machining a turned glossy surface, and then spraying the hub with a color celluloid paint.

2. The method according to claim 1, wherein the method comprises the steps of: pretreating→drying→spraying base powder→curing→spraying a black paint→curing→machining a turned glossy surface→pretreating→drying→spraying transparent powder→curing→spraying a color celluloid paint→curing.

3. The method according to claim 2, wherein the method adopts one or more of the following working conditions:
in the process of spraying base powder, an electrostatic spray gun is adopted for spraying, a voltage is controlled at 60˜80 KV, and a powder output is controlled at 10˜15 g/s, thereby ensuring excellent adhesion between coatings;
in the process of curing the base powder, a surface temperature of a workpiece is controlled at 180° C. for 8˜12 min, so that the powder maintains certain flexibility and better coating adhesion;
in the process of spraying a black paint, an air spray gun is adopted for spraying, an air output is controlled at 50˜100 cc/min, and an atomizing sector pressure is 2˜3 bar, thereby ensuring that the black paint is uniformly and fully sprayed on the surface of the hub;
in the process of curing the black paint, the temperature of the workpiece is controlled at 150° C. for 10˜15 min, so that the black paint has good flexibility and coating adhesion;
in the process of machining a turned glossy surface, a revolving speed S is controlled at 1200 rpm, and the feed rate F is 0.2 mm/r;
in the process of spraying transparent powder, an electrostatic spray gun is adopted for spraying, a voltage is controlled at 60˜80 KV, and a powder output is controlled at 10˜15 g/s, thereby ensuring excellent adhesion between coatings;
in the process of curing the transparent powder, the surface temperature of the workpiece is controlled at 177° C. for 10˜15 min, so that the powder maintains certain flexibility and better coating adhesion;
in the process of spraying a color celluloid paint, a rotary cup spray gun is adopted for spraying, the revolving speed is 25000 R/min, a forming gas is 2˜3 bar, and a paint output pressure is 4˜5 bar, thereby ensuring that the color celluloid paint is uniformly and fully sprayed on the surface of the hub; and
in the process of curing the color celluloid paint, the temperature of the workpiece is controlled at 150° C. for 10˜15 min, so that the color celluloid paint has better flexibility and coating adhesion.

4. The method according to claim 2, wherein,
in the process of spraying base powder, an electrostatic spray gun is adopted for spraying, the voltage is controlled at 60 KV, and the powder output is controlled at 10 g/s, thereby ensuring excellent adhesion between coatings;
in the process of curing the base powder, the surface temperature of a workpiece is controlled at 180° C. for 8 min, so that the powder maintains certain flexibility and better coating adhesion;
in the process of spraying a black paint, an air spray gun is adopted for spraying, the air output is controlled at 50 cc/min, and the atomizing sector pressure is 2 bar, thereby ensuring that the black paint is uniformly and fully sprayed on the surface of the hub;
in the process of curing the black paint, the temperature of the workpiece is controlled at 150° C. for 10 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 60 KV, and the powder output is controlled at 10 g/s, thereby ensuring excellent adhesion between coatings;
in the process of curing the transparent powder, the surface temperature of the workpiece is controlled at 177° C. for 8 min, so that the powder maintains certain flexibility and better coating adhesion;
in the process of spraying a color celluloid paint, a rotary cup spray gun is adopted for spraying, and the revolving speed is 25000 R/min; and
in the process of curing the color celluloid paint, the temperature of the workpiece is controlled at 150° C. for 10 min, so that the color celluloid paint has better flexibility and coating adhesion.

5. The method according to claim 2, wherein,
in the process of spraying base powder, an electrostatic spray gun is adopted for spraying, the voltage is controlled at 70 KV, and the powder output is controlled at 12 g/s, thereby ensuring excellent adhesion between coatings;
in the process of curing the base powder, the surface temperature of a workpiece is controlled at 180° C. for 10 min, so that the powder maintains certain flexibility and better coating adhesion;
in the process of spraying a black paint, an air spray gun is adopted for spraying, the air output is controlled at 80 cc/min, and the atomizing sector pressure is 2.5 bar, thereby ensuring that the black paint is uniformly and fully sprayed on the surface of the hub;
in the process of curing the black paint, the temperature of the workpiece is controlled at 150° C. for 12 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 70 KV, and the powder output is controlled at 12 g/s, thereby ensuring excellent adhesion between coatings;
in the process of curing the transparent powder, the surface temperature of the workpiece is controlled at 177° C. for 12 min, so that the powder maintains certain flexibility and better coating adhesion;
in the process of spraying a color celluloid paint, a rotary cup spray gun is adopted for spraying, the revolving speed is 25000 R/min, the forming gas is 2.5 bar, and the paint output pressure is 4.5 bar, thereby ensuring that the color celluloid paint is uniformly and fully sprayed on the surface of the hub; and
in the process of curing the color celluloid paint, the temperature of the workpiece is controlled at 150° C. for 12 min, so that the color celluloid paint has better flexibility and coating adhesion.

6. The method according to claim 2, wherein,
in the process of spraying base powder, an electrostatic spray gun is adopted for spraying, the voltage is controlled at 80 KV, and the powder output is controlled at 15 g/s, thereby ensuring excellent adhesion between coatings;
in the process of curing the base powder, the surface temperature of a workpiece is controlled at 180° C. for 12 min, so that the powder maintains certain flexibility and better coating adhesion;
in the process of spraying a black paint, an air spray gun is adopted for spraying, the air output is controlled at 100 cc/min, and the atomizing sector pressure is 3 bar, thereby ensuring that the black paint is uniformly and fully sprayed on the surface of the hub;
in the process of curing the black paint, the temperature of the workpiece is controlled at 150° C. for 15 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 80 KV, and the powder output is controlled at 15 g/s, thereby ensuring excellent adhesion between coatings;
in the process of curing the transparent powder, the surface temperature of the workpiece is controlled at 177° C. for 15 min, so that the powder maintains certain flexibility and better coating adhesion;
in the process of spraying a color celluloid paint, a rotary cup spray gun is adopted for spraying, the revolving speed is 25000 R/min, the forming gas is 3 bar, and the paint output pressure is 5 bar, thereby ensuring that the color celluloid paint is uniformly and fully sprayed on the surface of the hub; and
in the process of curing the color celluloid paint, the temperature of the workpiece is controlled at 150° C. for 15 min, so that the color celluloid paint has better flexibility and coating adhesion.

7. The method according to claim 3, wherein,
in the process of spraying base powder, an electrostatic spray gun is adopted for spraying, the voltage is controlled at 60 KV, and the powder output is controlled at 10 g/s, thereby ensuring excellent adhesion between coatings;
in the process of curing the base powder, the surface temperature of a workpiece is controlled at 180° C. for 8 min, so that the powder maintains certain flexibility and better coating adhesion;
in the process of spraying a black paint, an air spray gun is adopted for spraying, the air output is controlled at 50 cc/min, and the atomizing sector pressure is 2 bar, thereby ensuring that the black paint is uniformly and fully sprayed on the surface of the hub;
in the process of curing the black paint, the temperature of the workpiece is controlled at 150° C. for 10 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 60 KV, and the powder output is controlled at 10 g/s, thereby ensuring excellent adhesion between coatings;
in the process of curing the transparent powder, the surface temperature of the workpiece is controlled at 177° C. for 8 min, so that the powder maintains certain flexibility and better coating adhesion;
in the process of spraying a color celluloid paint, a rotary cup spray gun is adopted for spraying, and the revolving speed is 25000 R/min; and
in the process of curing the color celluloid paint, the temperature of the workpiece is controlled at 150° C. for 10 min, so that the color celluloid paint has better flexibility and coating adhesion.

8. The method according to claim 3, wherein,
in the process of spraying base powder, an electrostatic spray gun is adopted for spraying, the voltage is controlled at 70 KV, and the powder output is controlled at 12 g/s, thereby ensuring excellent adhesion between coatings;
in the process of curing the base powder, the surface temperature of a workpiece is controlled at 180° C. for 10 min, so that the powder maintains certain flexibility and better coating adhesion;
in the process of spraying a black paint, an air spray gun is adopted for spraying, the air output is controlled at 80 cc/min, and the atomizing sector pressure is 2.5 bar, thereby ensuring that the black paint is uniformly and fully sprayed on the surface of the hub;
in the process of curing the black paint, the temperature of the workpiece is controlled at 150° C. for 12 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 70 KV, and the powder output is controlled at 12 g/s, thereby ensuring excellent adhesion between coatings;
in the process of curing the transparent powder, the surface temperature of the workpiece is controlled at 177° C. for 12 min, so that the powder maintains certain flexibility and better coating adhesion;
in the process of spraying a color celluloid paint, a rotary cup spray gun is adopted for spraying, the revolving speed is 25000 R/min, the forming gas is 2.5 bar, and the paint output pressure is 4.5 bar, thereby ensuring that the color celluloid paint is uniformly and fully sprayed on the surface of the hub; and
in the process of curing the color celluloid paint, the temperature of the workpiece is controlled at 150° C. for 12 min, so that the color celluloid paint has better flexibility and coating adhesion.

9. The method according to claim 3, wherein,
in the process of spraying base powder, an electrostatic spray gun is adopted for spraying, the voltage is controlled at 80 KV, and the powder output is controlled at 15 g/s, thereby ensuring excellent adhesion between coatings;
in the process of curing the base powder, the surface temperature of a workpiece is controlled at 180° C. for 12 min, so that the powder maintains certain flexibility and better coating adhesion;
in the process of spraying a black paint, an air spray gun is adopted for spraying, the air output is controlled at 100 cc/min, and the atomizing sector pressure is 3 bar, thereby ensuring that the black paint is uniformly and fully sprayed on the surface of the hub;
in the process of curing the black paint, the temperature of the workpiece is controlled at 150° C. for 15 min, so that the black paint has good flexibility and coating adhesion;
in the process of machining a turned glossy surface, the revolving speed S is controlled at 1200 rpm, and the feed rate F is 0.2 mm/r;
in the process of spraying transparent powder, the electrostatic spray gun is adopted for spraying, the voltage is controlled at 80 KV, and the powder output is controlled at 15 g/s, thereby ensuring excellent adhesion between coatings;
in the process of curing the transparent powder, the surface temperature of the workpiece is controlled at 177° C. for 15 min, so that the powder maintains certain flexibility and better coating adhesion;
in the process of spraying a color celluloid paint, a rotary cup spray gun is adopted for spraying, the revolving speed is 25000 R/min, the forming gas is 3 bar, and the paint output pressure is 5 bar, thereby ensuring that the color celluloid paint is uniformly and fully sprayed on the surface of the hub; and
in the process of curing the color celluloid paint, the temperature of the workpiece is controlled at 150° C. for 15 min, so that the color celluloid paint has better flexibility and coating adhesion.
